(19) United States
(12) Patent Application Publication
(10) Pub. No.: US 2002/0182356 A1
(43) Pub. Date: Dec. 5, 2002

(54) Tube for transporting a coolant in an internal combustion engine

(76) Inventor: Jerome Guippe, Morancez (FR)

Correspondence Address: BIRCH STEWART KOLASCH & BIRCH, PO BOX 747, FALLS CHURCH, VA, 22040-0747, US

(21) Appl. No.: 10/148,485

(22) PCT Filed: Nov. 30, 2000
(86) PCT No.: PCT/FR00/03348

(30) Foreign Application Priority Data
Dec. 9, 1999 (FR) 99 15534
Jan. 14, 2000 (FR) 00 00452

(51) Int. Cl. B32B 1/08

(52) U.S. Cl. 428/36.91

(57) ABSTRACT

A pipe for transferring a coolant in a motor vehicle engine, the pipe being formed by a layer of thermoplastic elastomer material (TPE) and a layer of thermoplastic material formed by a polyamide and polypropylene alloy.

### BACKGROUND OF THE INVENTION

The major problem to be resolved in the field of manufacturing tubes made of synthetic material for transporting motor vehicle fluids (fuel, coolant, screen wash, air-conditioning fluid, . . . ) lies in finding a compromise between the performance to be obtained with regard to the numerous requirements of motor vehicle manufacturers, and the raw materials and manufacturing costs for this type of product.

If the cost of the product can be disregarded, then it is relatively easy to satisfy the requirements of manufacturers. However, there is no market for the products thus obtained because they are too costly, but when attempts are made to provide low cost products, the requirements are no longer satisfied.

### OBJECT AND SUMMARY OF THE INVENTION

The invention relates to a structure which is an acceptable compromise between the contradictory requirements with regard to performance and cost.

Thus to this end, the invention provides a pipe for transferring a coolant in a motor vehicle engine, which pipe is formed by a layer of thermoplastic elastomer material and a layer of thermoplastic material formed by a polyamide and polypropylene alloy.

### DETAILED DESCRIPTION OF THE INVENTION

A thermoplastic elastomer (TPE) material is used because of the many advantages provided as a result of the rubber character of said material. A flexible pipe can be obtained in this way which is easier to thermoform, thermoforming being applied to the thermoplastic material of the polyamide/polypropylene-mix type. Furthermore, TPE constitutes a damper integrated in the pipe, which damper enables the sound emissions created in said pipe to be reduced, in particular when said sound emissions originate from sudden pressure variations within the fluid.

The combined use firstly of a TPE and secondly of a polypropylene/polyamide alloy has the advantage of being able to eliminate any intermediate bonding layer between the two substances since said substances are entirely compatible with each other. Finally, the thermoplastic elastomer TPE does not require any post-vulcanizing operation. These last two characteristics are a factor in reducing the manufacturing cost of the pipe of the invention.

Compared with a low cost polypropylene or polyethylene, selecting a polypropylene/polyamide alloy such as a thermoplastic material that is rigid but nevertheless thermoformable improves the ability of the material to withstand temperature. The presence of polyamide in the polypropylene is a factor in increasing temperature resistance while partially conserving the economic advantage of polypropylene over polyamide. The polypropylene combined with polyamide is a factor in increasing resistance to hydrolysis which is known to be insufficient for polyamide, while making the final substance less costly than polyamide on its own.

The pipe of the invention can be in two forms depending on whether the thermoplastic material forms the inner layer or the outer layer of said pipe.

When the elastomer material forms the inner layer of the pipe, said pipe has the property of being easily connectable to rigid endpieces provided with external projections such as nipples or spigots, e.g. merely by force fitting, the deformability of the TPE enabling the connection to be made without having to use significant force and enabling the connection to be well sealed. In this configuration, the outer thermoplastic material enables any type of element useful for fixing said pipe to be added to the pipe, e.g. tabs, flanges, collars, . . . , merely by vibration or ultrasound welding.

In a variant, the layer of polypropylene/polyamide alloy can be covered on the outside in a protective layer preferably made of impact modified polyamide (of type PA6 in particular) so as to limit the risk of the pipe deteriorating as a result of impacts.

In the embodiment in which the thermoplastic elastomer material forms the outer layer, said material constitutes a protective layer for protecting the inner layer made of polypropylene/polyamide alloy, an alloy that is relatively fragile and that can crack under the effect of external impacts. This structure enables each of the ends of such a pipe to be fitted with a rigid endpiece by welding or by using any other means for connecting said endpiece to the inner layer made of polypropylene and polyamide, the other end of the endpiece constituting a rigid element suitable, for example, for co-operating with pipe snap-fastening means such as those whose use is expanding in the motor industry. Finally, a pipe which has an outer elastomeric layer has the advantage of being soft to the touch which forms part of the requirements to be satisfied as drawn up by motor vehicle manufacturers.

By way of indication, it should be mentioned that a polypropylene/polyamide alloy known as ORGALLOY from the supplier ATO exists on the market, while the thermoplastic elastomer material which is a matrix of polypropylene with nodules of ethylene-propylene diene monomer (EPDM) is present on the market at least under the trademarks SANTOPRENE and SARLINK.

1. A pipe for transferring a coolant in a motor vehicle engine, the pipe being formed by a layer of thermoplastic elastomer material (TPE) and a layer of thermoplastic material formed by a polyamide and polypropylene alloy.

2. A pipe according to claim 1, wherein the elastomer material is an inner layer, the polyamide/polypropylene alloy forming a layer covering the elastomer material.

3. A pipe according to claim 2, wherein a protective layer covers the outside of the polyamide/polypropylene alloy.

4. A pipe according to claim 3, wherein the protective layer is made of impact modified polyamide.

5. A pipe according to claim 1, wherein the elastomer material is an outer layer, and wherein the polyamide/polypropylene alloy is an inner layer.
